(19) United States
(12) Patent Application Publication
(10) Pub. No.: US 2025/0251196 A1
(43) Pub. Date: Aug. 7, 2025

(54) EVAPORATIVE MEDIA

(71) Applicant: MUNTERS CORPORATION, Amesbury, MA (US)

(72) Inventors: ANNETTE DWYER, Fort Myers Beach, FL (US); HANS-JOACHIM KRUGER, Kingston, NH (US); JUAN GALINDO, Guadalupe (MX)

(21) Appl. No.: 18/433,006

(22) Filed: Feb. 5, 2024

(51) Int. Cl. F28C 1/04

(52) U.S. Cl. CPC F28C 1/04

(57) ABSTRACT

A method and system of replacing evaporative media is usable with an evaporative cooling apparatus including a media housing having predetermined dimensions. The method and system include removing first evaporative media from the media housing, and installing second evaporative media in the media housing. The second evaporative media has dimensions complementary to predetermined dimensions of the media housing and substantially equal to the dimensions of the first evaporative media. The second evaporative media has a pressure drop factor that differs from a first pressure drop factor.

### FIELD OF THE INVENTION

The invention relates to evaporative cooling systems, that is, conditioning systems that utilize thermodynamic laws to cool a fluid. Namely, a change of a fluid from a liquid phase to a vapor phase can result in a reduction in temperature due to the heat of vaporization involved in the phase change.

### BACKGROUND OF THE INVENTION

Evaporative cooling solutions include direct evaporative coolers, where water is evaporated into the air stream via an engineered pad to provide adiabatic cooling, and indirect evaporative coolers, where evaporating water is used to cool a scavenger airstream passing through a heat exchanger, thus maintaining constant humidity in the treated air. Direct and indirect evaporative coolers are extremely energy efficient, negating the need for compressors in the cooling cycle.

FIG. 8 represents a schematic of a typical direct evaporative cooler 100. Water or another suitable cooling liquid is recirculated from a reservoir 110 through a supply line 112 to a distributor 116 using a pump 114. Distributor 116 evenly distributes the supplied water over a heat exchanger, such as evaporative pad 118. Supply air 124 is passed through the pad, where it is cooled and humidified to exit as cold air 126. The water fed from distributor 16 flows down and through the pad and evaporates as it meets the warm supply air 124. A bleed stream controlled by valve 120, for example, is removed from the system through bleed or drain line 121 to drain 122 to control mineral build-up in the water. Fresh make-up water is added as needed from water supply 128 to replace the water evaporated and bled. The make-up water can be controlled by a float valve or other level sensing means (not shown) provided in the reservoir 110.

Various forms of evaporative media are known. For example, U.S. Pat. No. 5,143,658, which is incorporated by reference herein and shown in FIGS. 6 and 7, describes evaporative media formed of first and second sets of corrugated sheet material arranged with the sheets of the first set disposed alternately with the sheets of the second set. The corrugations of the sheets define passageways which penetrate the contact body from edge to edge with both vertical and horizontal components of direction. The passageways are simultaneously passed by a flow of gas in one direction and liquid in the other direction in either counterflow or cross-flow. The corrugations of the first set of sheets cross the corrugations of the second set of sheets at an acute angle in the range of 15° to 80°. Corrugations of the first set of sheets have a greater inclination to the horizontal plane of the contact apparatus than the corrugations of the second set of sheets and the corrugations of the first set of sheets have a smaller amplitude dimension than the corrugations of the second set of sheets. Corrugations in the first set of sheets are inclined upwardly in the direction of gas flow and the corrugations in the second set of sheets are inclined downwardly in the direction of gas flow, whereby undesirable lateral displacement of the liquid stream caused by the gas flow is counteracted and the liquid is distributed uniformly and evenly over the sheets.

Examples of evaporative media on the market include CELdek™ pads and GLASdek™ pads manufactured by Munters Corporation. GLASdek™ GX30™, for example, is a high-performance evaporative media made from inorganic, non-combustible material. GLASdek GX40™ is also made from inorganic, non-combustible material, but is further impregnated with ceramic double coating.

Such evaporative media are often manufactured in the form of a cassette that can be installed in the frame of an air handling unit (AHU). In the cassette, the evaporative media is housed in a material, such as reinforced steel. The frame of the AHU, such as those used in the cooling of data centers, is designed to house a cassette of a specific size. While the evaporative media available on the market is very efficient from a cooling standpoint, in some situations the original media cassette may provide more cooling capacity than needed. Due to the excess cooling capacity, unnecessary energy costs may arise, such as excess fan usage to pull the air with an unneeded pressure drop as well as excess water usage. In order to scale down the cooling capacity, a cassette of a smaller size can be used, for example, a cassette of a smaller depth. In such a scenario, however, the frame of the AHU may need to be redesigned, adding costs to the system.

### SUMMARY OF THE INVENTION

In one aspect, the invention relates to a method of replacing evaporative media for gas and liquid contact in an evaporative cooling apparatus, the evaporative cooling apparatus including a media housing having predetermined dimensions, and the evaporative media being positioned in the media housing and having a pressure drop factor representing a pressure drop of the gas flowing through the evaporative media from an inlet side to an outlet side. The method includes removing first evaporative media from the media housing, the first evaporative media having dimensions complementary to the predetermined dimensions of the media housing, the first evaporative media having a first pressure drop factor; and installing second evaporative media in the media housing, the second evaporative media having dimensions complementary to the predetermined dimensions of the media housing and substantially equal to the dimensions of the first evaporative media, the second evaporative media having a second pressure drop factor that differs from the first pressure drop factor.

In another aspect, the invention relates to a system employing replaceable evaporative media for gas and liquid contact, the system comprising an evaporative cooling apparatus, the evaporative cooling apparatus including a media housing having predetermined dimensions, the replaceable evaporative media being positionable in the media housing and having a pressure drop factor representing a pressure drop of the gas flowing through the evaporative media from an inlet side to an outlet side; first evaporative media insertable in and removable from the media housing, the first evaporative media having dimensions complementary to the predetermined dimensions of the media housing, the first evaporative media having a first pressure drop factor; and second evaporative media insertable in and removable from the media housing, the second evaporative media having dimensions complementary to the predetermined dimensions of the media housing and substantially equal to the dimensions of the first evaporative media, the second evaporative media having a second pressure drop factor that differs from the first pressure drop factor.

In a further aspect, the invention relates to evaporative media for gas and liquid contact, in which the gas and the liquid flow in a cross-flow relationship to one another, the evaporative media comprising a first set of corrugated sheets having flutes of a first height; and a second set of corrugated sheets having flutes of a second height. The corrugated sheets of the first set are disposed alternatively with the corrugated sheets of the second set, with the flutes of the first set crossing the flutes of the second set so as to define passageways from one surface to another surface of the evaporative media, the flutes of the corrugated sheets of the first set contact the flutes of the corrugated sheets of the second set at crests of the flutes, the flutes of the first set of corrugated sheets incline upwardly at a first inclination angle with respect to a direction of gas flow, while the flutes of the second set of corrugated sheets incline downwardly at a second inclination angle with respect to the direction of gas flow, absolute values of the first inclination angle and the second inclination angle are not equal, an amplitude of the flutes of the first set of corrugated sheets from trough to crest is less than an amplitude of the flutes of the second set of corrugated sheets from trough to crest, and the amplitude of the flutes of the first set of corrugated sheets is substantially 8 mm and the amplitude of the flutes of the second set of corrugated sheets is substantially 10 mm.

These and other aspects and advantages will become apparent when the description below is read in conjunction with the accompanying drawings.

### BRIEF DESCRIPTION OF THE DRAWINGS

FIG. 1 shows an evaporative media cassette according to an embodiment of the present invention.

FIG. 2 is an enlarged view of an embodiment of the evaporative media of the present invention.

FIG. 3 is a graph showing pressure drop versus face velocity in comparing an embodiment of the present invention with comparative examples.

FIG. 4 is a graph showing cooling efficiency versus face velocity in comparing the embodiment of the present invention with the comparative examples.

FIG. 5 shows an example of evaporative media.

FIG. 6 shows an embodiment of evaporative media.

FIG. 7 is a cross-section of the evaporative media shown in FIG. 6.

FIG. 8 is a schematic view of a typical direct evaporative cooling system.

### DETAILED DESCRIPTION OF THE PREFERRED EMBODIMENTS

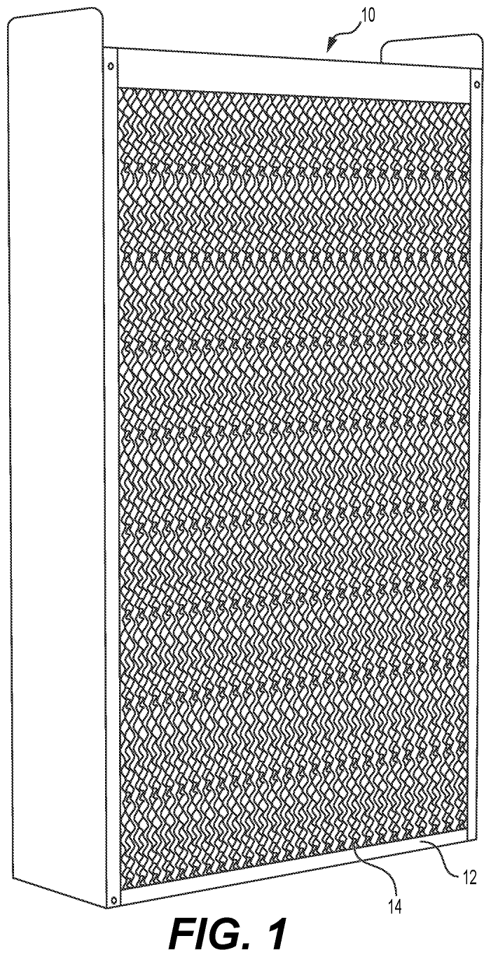

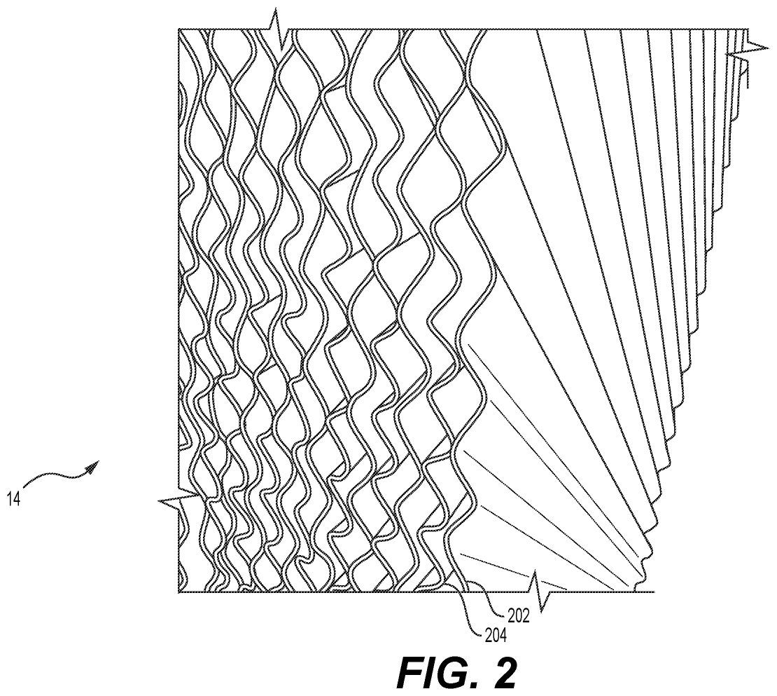

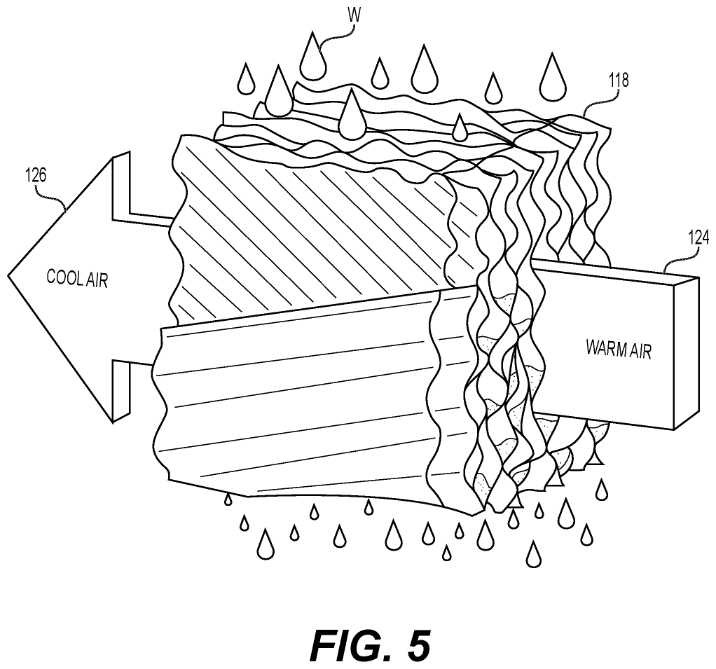

FIG. 1 shows an evaporative media cassette in accordance with a preferred embodiment of the invention. Evaporative media cassette 10 is formed of a-frame 12 made of a rigid material such as stainless steel, and evaporative media 14 held by the frame, and is designed to be mountable in and removable from a cassette housing of a cooling apparatus, such as an evaporative cooler used in data centers. The cassette 10 can be of any suitable shape and size, and is typically designed based on the cooling needs of the target of its use. As shown, the frame 12 is of a rectangular shape, having specified height, width, and depth dimensions, so as to secure similarly-sized evaporative media. The dimensions of the cassette 10 are designed to be of complementary, that is, substantially equal to, dimensions of the housing of the cooling apparatus. In one aspect, evaporative media 14 is designed to have a lower pressure drop of air passing therethrough when compared to other media products on the market of comparable depth. The evaporative media 14 can have a similar design as the GX 30™ product shown in FIG. 5, but with important design changes so as to improve, that is, decrease, pressure drop.

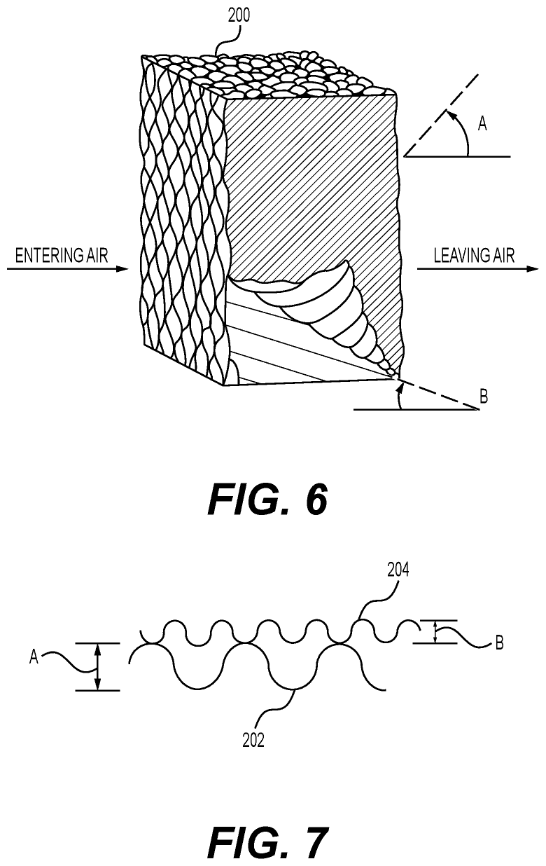

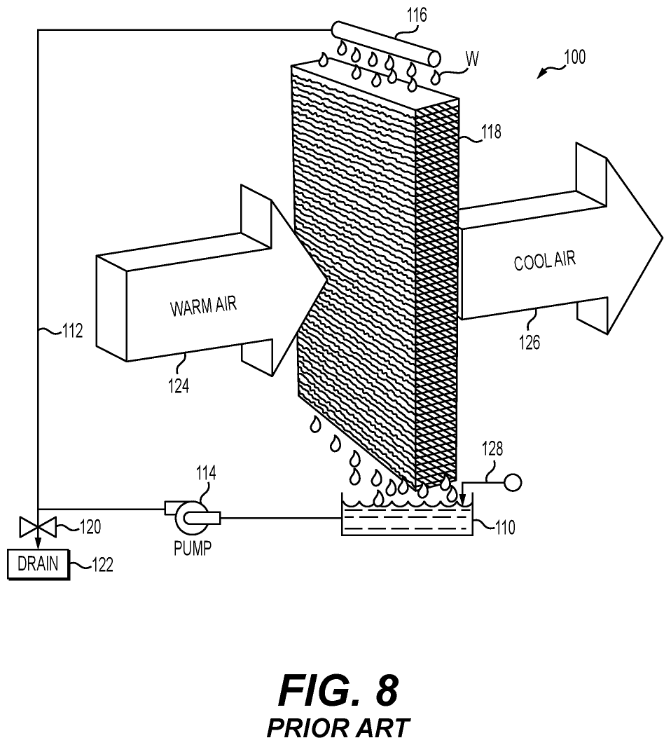

In that regard, referring to FIG. 6, evaporative media 14 of the present embodiment is similarly formed of flutes, like the GX30™ product. The evaporative media 14 is formed of first and second sets of corrugated sheets 202, 204, each having flutes of different heights.

The corrugated sheets 202 of the first set are disposed alternately with the corrugated sheets 204 of the second set, with the flutes of the first set crossing the flutes of the second set so as to define passageways from one surface to another surface of the evaporative media. The flutes of the corrugated sheets 202 of the first set contact the flutes of the corrugated sheets 204 of the second set at crests of the flutes. The flutes of the first set of corrugated sheets 202 incline upwardly at a first inclination angle A with respect to a direction of gas flow, while the flutes of the second set of corrugated sheets incline downwardly at a second inclination angle B with respect to the direction of gas flow. Absolute values of the first inclination angle A and the second inclination angle B are not equal. An amplitude X of the flutes of the first set of corrugated sheets 202 from trough to crest is less than an amplitude Y of the flutes of the second set of corrugated sheets 204 from trough to crest. In a preferred embodiment, in order reduce pressure drop across a similar thickness or depth, the amplitude X of the flutes of the first set of corrugated sheets 202 is substantially 8 mm and the amplitude Y of the flutes of the second set of corrugated sheets 204 is substantially 10 mm. In the preferred embodiment, the inclination angle A of the flutes of the first set of sheets 202 is substantially 15° from the horizontal, and the inclination angle B of the flutes of the second set of sheets 204 is substantially 45° from the horizontal.

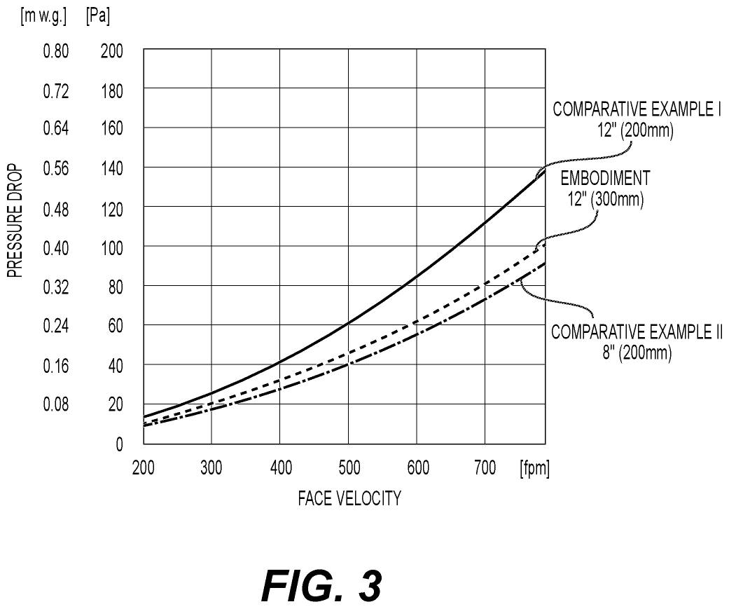

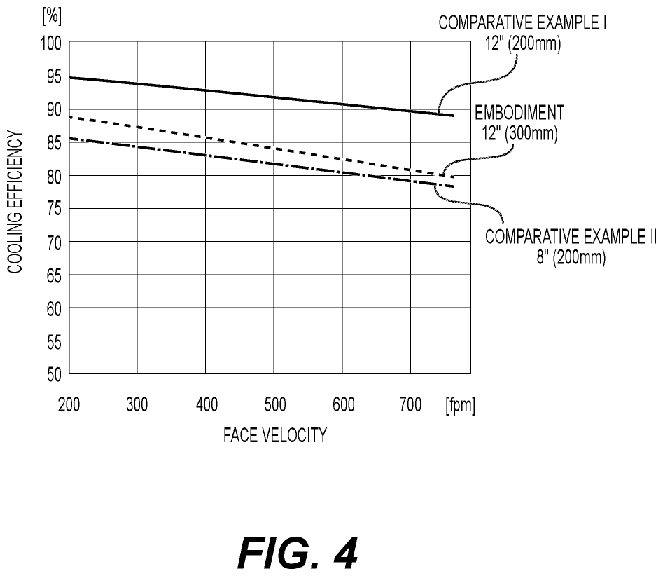

Comparative testing was performed between the embodiment of the present invention as described above and two comparative examples. Both the embodiment of the present invention and Comparative Example I had identical external dimensions, whereas Comparative Example II had a smaller depth, that is, 8 inches (200 mm) versus 12 inches (300 mm). Graphs showing pressure drop versus face velocity and cooling efficiency versus face velocity are shown in FIGS. 3 and 4, respectively. As shown in FIG. 3, the evaporative media of the present embodiment had a significantly lower pressure drop than that in Comparative Example I, yet quite similar to the pressure drop of Comparative Example II. Likewise, as shown in FIG. 4, the cooling efficiency of the present embodiment was lower than that of Comparative Example I, and somewhat similar to Comparative Example II. Cooling efficiency was determined using known formula based on wet and dry bulb temperatures. However, since the evaporative media of the present embodiment was of the same external dimensions as that of Comparative Example I, it can readily fit inside the frame of the AHU without any modification. Comparative Example II would require a retrofit of the frame due to its smaller depth.

In the method of using the present invention, evaporative media of the preferred embodiment can readily replace original evaporative media when less cooling efficiency is needed. This will enable cost savings because the replaced evaporative media results in a lower pressure drop through the media, thereby reducing fan usage, and less water is needed.

Thus, the evaporative media of the present invention can provide an increased energy-saving alternative to existing media with the same size and similar benefits, but with lower pressure drop. The evaporative media of the present invention can be manufactured in the same depths as existing media so that no modifications would be required to the frame or the water distribution system. That is, the evaporative media of the present invention enables energy and water saving by scaling down excess cooling capacity of an existing installation. The low pressure drop design saves energy and water while still achieving acceptable cooling efficiency.

Of course, the invention is not intended to be limited to the dimensions described above. That is, while the present invention describes specific dimensions, for example, the angles and sizes of the corrugated sheets, what is important is that the replacement evaporative media be of a comparable external size as the original evaporative media, yet be designed to be of a lower pressure drop while still maintaining a desired level of cooling efficiency. Nor is the invention intended to be limited to the specific type of evaporative media described herein. Many types of evaporative media are known, such as cellulose, aspen wood fiber, and synthetic fiber media, and various designs have been proposed based on these materials. Redesigning the materials so as to alter pressure drop while maintaining the same exterior dimensions can be considered to be within the scope of the invention.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. A method of replacing evaporative media for gas and liquid contact in an evaporative cooling apparatus, the evaporative cooling apparatus including a media housing having predetermined dimensions, the evaporative media being positioned in the media housing and having a pressure drop factor representing a pressure drop of the gas flowing through the evaporative media from an inlet side to an outlet side, the method comprising:
removing first evaporative media from the media housing, the first evaporative media having dimensions complementary to the predetermined dimensions of the media housing, the first evaporative media having a first pressure drop factor; and
installing second evaporative media in the media housing, the second evaporative media having dimensions complementary to the predetermined dimensions of the media housing and substantially equal to the dimensions of the first evaporative media, the second evaporative media having a second pressure drop factor that differs from the first pressure drop factor.

2. The method according to claim 1, wherein the second evaporative media having the second pressure drop factor has a lower pressure drop of the gas flowing through the evaporative media from the inlet side to the outlet side than that of the first evaporative media under the same conditions.

3. The method according to claim 1, wherein the second evaporative media is formed of a first set of corrugated sheets having flutes of a first amplitude from trough to crest and a second set of corrugated sheets having flutes of a second amplitude from trough to crest, with the corrugated sheets of the first set being disposed alternately with the corrugated sheets of the second set, the flutes of the first set of corrugated sheets inclining upwardly at a first inclination angle with respect to a direction of gas flow and the flutes of the second set of corrugated sheets inclining downwardly at a second inclination angle with respect to the direction of gas flow, and absolute values of the first inclination angle and the second inclination angle being unequal.

4. The method according to claim 3, wherein the first amplitude of the flutes of the first set of sheets is substantially 8 mm.

5. The method according to claim 3, wherein the second amplitude of the flutes of the second set of sheets is substantially 10 mm.

6. The method according to claim 3, wherein the first inclination angle of the flutes of the first set of sheets is substantially 45° from the horizontal.

7. The method according to claim 3, wherein the second inclination angle of the flutes of the second set of sheets is substantially 15° from the horizontal.

8. The method according to claim 1, wherein the first evaporative media has a first cooling efficiency factor and the second evaporative media has a second cooling efficiency factor that substantially differs from the first cooling efficiency factor.

9. The method according to claim 8, wherein the second evaporative media having the second cooling efficiency factor is less efficient in cooling the gas flowing through the evaporative media from the inlet side to the outlet side than that of the first evaporative media under the same conditions.

10. A system employing replaceable evaporative media for gas and liquid contact, the system comprising:
an evaporative cooling apparatus, the evaporative cooling apparatus including a media housing having predetermined dimensions, the replaceable evaporative media being positionable in the media housing and having a pressure drop factor representing a pressure drop of the gas flowing through the evaporative media from an inlet side to an outlet side;
first evaporative media insertable in and removable from the media housing, the first evaporative media having dimensions complementary to the predetermined dimensions of the media housing, the first evaporative media having a first pressure drop factor; and
second evaporative media insertable in and removable from the media housing, the second evaporative media having dimensions complementary to the predetermined dimensions of the media housing and substantially equal to the dimensions of the first evaporative media, the second evaporative media having a second pressure drop factor that differs from the first pressure drop factor.

11. The system according to claim 10, wherein the second evaporative media having the second pressure drop factor has a lower pressure drop of the gas flowing through the evaporative media from the inlet side to the outlet side than that of the first evaporative media under the same conditions.

12. The system according to claim 10, wherein each of the first evaporative media and the second evaporative media is formed of a first set of corrugated sheets having flutes of a first amplitude from trough to crest and a second set of corrugated sheets having flutes of a second amplitude from trough to crest, with the corrugated sheets of the first set being disposed alternately with the corrugated sheets of the second set, the flutes of the first set of corrugated sheets inclining upwardly at a first inclination angle with respect to a direction of gas flow and the flutes of the second set of corrugated sheets inclining downwardly at a second inclination angle with respect to the direction of gas flow, and absolute values of the first inclination angle and the second inclination angle being unequal.

13. The system according to claim 12, wherein the first amplitude of the flutes of the first set of sheets is substantially 8 mm.

14. The system according to claim 12, wherein the second amplitude of the flutes of the second set of sheets is substantially 10 mm.

15. The system according to claim 12, wherein the first inclination angle of the flutes of the first set of sheets is substantially 45° from the horizontal.

16. The system according to claim 12, wherein the second inclination angle of the flutes of the second set of sheets is substantially 15° from the horizontal.

17. The system according to claim 10, wherein the first evaporative media has a first cooling efficiency factor and the second evaporative media has a second cooling efficiency factor that substantially differs from the first cooling efficiency factor.

18. The system according to claim 17, wherein the second evaporative media having the second cooling efficiency factor is less efficient in cooling the gas flowing through the evaporative media from the inlet side to the outlet side than that of the first evaporative media under the same conditions.

19. Evaporative media for gas and liquid contact, in which the gas and the liquid flow in a cross-flow relationship to one another, the evaporative media comprising:
a first set of corrugated sheets having flutes of a first height;
a second set of corrugated sheets having flutes of a second height, wherein
the corrugated sheets of the first set are disposed alternatively with the corrugated sheets of the second set, with the flutes of the first set crossing the flutes of the second set so as to define passageways from one surface to another surface of the evaporative media, the flutes of the corrugated sheets of the first set contact the flutes of the corrugated sheets of the second set at crests of the flutes,
the flutes of the first set of corrugated sheets incline upwardly at a first inclination angle with respect to a direction of gas flow, while the flutes of the second set of corrugated sheets incline downwardly at a second inclination angle with respect to the direction of gas flow,
absolute values of the first inclination angle and the second inclination angle are not equal,
an amplitude of the flutes of the first set of corrugated sheets from trough to crest is less than an amplitude of the flutes of the second set of corrugated sheets from trough to crest, and
the amplitude of the flutes of the first set of corrugated sheets is substantially 8 mm and the amplitude of the flutes of the second set of corrugated sheets is substantially 10 mm.

20. The evaporative media according to claim 19, wherein the first inclination angle of the flutes of the first set of sheets is substantially 45° from the horizontal and the second inclination angle of the flutes of the second set of sheets is substantially 15° from the horizontal.
